(19) United States
(12) Patent Application Publication
(10) Pub. No.: US 2024/0211798 A1
(43) Pub. Date: Jun. 27, 2024

(54) INDUSTRIAL MONITORING PLATFORM

(71) Applicant: Delaware Capital Formation, Inc., Wilmington, DE (US)

(72) Inventors: Prem Swaroop, Lexington, MA (US); Bodhayan Dev, Sturbridge, MA (US); Sreedhar Patnala, Holliston, MA (US); Girish Juneja, Lexington, MA (US)

(21) Appl. No.: 18/087,630

(22) Filed: Dec. 22, 2022

(51) Int. Cl. G06N 20/00; G06F 11/34

(52) U.S. Cl. CPC G06N 20/00; G06F 11/3495

(57) ABSTRACT

Methods, systems, and apparatus, including computer programs encoded on computer for an industrial machine-learning operation model monitoring system, that include the actions of receiving monitoring data for an industrial machine-learning operations model, determining, from the monitoring data, to retrain the industrial machine-learning operations model, where the determining includes computing drift parameters, each of the drift parameters being indicative of a type of observable drift of the industrial machine-learning operations model, where the drift parameters include (i) a usage drift, (ii) a performance drift, (iii) a data drift, and (iv) a prediction drift, and where each drift parameter includes a respective retraining criteria, and confirming, from the drift parameters, the respective retraining criteria is met by at least one of the drift parameters, and triggering, in response to the determining to retrain the industrial machine-learning operations model, an update of the industrial machine-learning operations model.

### FIELD OF INVENTION

The present systems and techniques relate to industrial machine-learning operations model system-monitoring.

### BACKGROUND

Machine-learning models deployed into production environments may degrade over time, e.g., due to the dynamic nature of machine-learning models and potential sensitivity to real-world changes in the production environment(s) in which the models are deployed. Degradation in the machine-learning model can lead to low quality prediction data and reduced usage of the machine-learning model.

### SUMMARY

This specification describes technologies for a machine-learning model monitoring. These technologies generally involve a system for monitoring health of one or more industrial machine-learning operations (MLOPs) models deployed in one or more production environments. The framework can monitor different types of observable drift to trigger updates to the industrial MLOPs model(s). An update to an industrial MLOPs model can include a retraining pipeline to improve performance of the deployed industrial MLOPs model in the production environment.

In general, one innovative aspect of the subject matter described in this specification can be embodied in methods for an industrial machine-learning operation model monitoring system, including receiving, from one or more computing devices, monitoring data for an industrial machine-learning operations model. The system determines, from the monitoring data, to retrain the industrial machine-learning operations model, where the determining includes computing drift parameters, each of the drift parameters being indicative of a type of observable drift of the industrial machine-learning operations model, where the drift parameters include (i) a usage drift, (ii) a performance drift, (iii) a data drift, and (iv) a prediction drift, and where each drift parameter includes a respective retraining criteria, and confirming, from the drift parameters, the respective retraining criteria is met by at least one of the drift parameters. The system triggers, in response to the determining to retrain the industrial machine-learning operations model, an update of the industrial machine-learning operations model.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some embodiments, monitoring data for the industrial machine-learning operations model includes monitoring (A) model usage data, (B) model performance data, (C) sensor data, and (D) prediction data.

In some embodiments, triggering the updated of the industrial machine-learning operations model includes generating an updated industrial machine-learning operations model, and providing, to the one or more computing devices, the updated industrial machine-learning operations model.

In some embodiments, generating an updated industrial machine-learning operations model includes generating a refined training data set, and retraining the industrial machine-learning operations model to generate the updated industrial machine-learning operations model.

In some embodiments, generating the refined training data set includes one or more of (i) relabeling and/or reannotating an original training set, and (ii) generating a new training set including new prediction data collected by the one or more computing devices.

In some embodiments, the methods further include determining a first performance parameter for the updated industrial machine-learning operations model exceeds a second performance parameter for the industrial machine-learning operations model, and providing, to the one or more computing devices, the updated industrial machine-learning operations model. Determining that the first performance parameter for the updated industrial machine-learning operations model exceeds the second performance parameter for the industrial machine-learning operations model can include comparing a first output of the updated industrial machine-learning operations model utilizing an exemplary data set and a second output of the industrial machine-learning operations model utilizing the exemplary data set.

In some embodiments, drift parameters include weighted drift parameters, where determining the respective retraining criteria is met by at least one of the drift parameters includes determining that a weighted retraining criteria is met by the weighted drift parameters.

In some embodiments, the data drift includes metadata drift.

In some embodiments, meeting the respective retraining criteria for each drift parameter of the drift parameters depends in part on the type of observable drift of the drift parameter. In some embodiments, the respective retraining criteria is met by at least two of the drift parameters.

In some embodiments, triggering the update includes providing an alert to initiate a retraining pipeline.

In some embodiments, triggering the update includes triggering an automatic retraining of the industrial machine-learning operations model.

In some embodiments, determining the drift parameters based on usage drift includes determining a frequency of utilization of the industrial machine-learning operations model by the one or more computing devices over a first period of time, where the respective retraining criteria for the drift parameter based on the usage drift includes a minimum threshold usage of the industrial machine-learning operations model for a second period of time.

In some embodiments, determining the drift parameters based on performance drift includes determining a compute time for the industrial machine-learning operations model on available hardware of the one or more computing devices, where the respective retraining criteria for the drift parameters based on the performance drift includes a deviation of the compute time from an average compute time for the industrial machine-learning operations model on the available hardware of the one or more computing devices.

In some embodiments, monitoring data includes prediction data, where determining the drift parameters based on data drift includes determining a deviation of the prediction data generated utilizing the industrial machine-learning operations model from training data utilized to train the industrial machine-learning operations model. Determining the drift parameters based on prediction drift can include determining an accuracy in the prediction data is below a threshold prediction accuracy.

In some embodiments, triggering the update includes providing an alert to a user, and in response to receiving a confirmation from the user to initiate a retraining pipeline, initiating the retraining pipeline.

The subject matter described in this specification can be implemented in these and other embodiments so as to realize one or more of the following advantages. Improved feedback mechanisms can result in increased accuracy of the machine-learned model predictions and overall higher deployed adoption rates. Moreover, by utilizing multiple metrics for computing machine-learned model health scores, degradation can be identified, and optionally tracked, at earlier stages of drift, and intervention can be done to correct such degradation ahead of larger machine-learned model performance issues. Tracking multiple drift types including data drift, prediction drift, performance drift, and usage drift can provide enhanced tracking mechanisms for monitoring health of a machine-learned model. Thus, the monitoring of the health of a trained machine-learning model can be more robust in that the need for retraining is identified sooner, or in circumstances that would not trigger a retraining by prior art systems and techniques.

The multiple drift types for computing health scores of the machine-learned model can be selected to reduce a response time for initiating a retraining of the machine-learned model and/or to increase a prediction accuracy of a deployed machine-learned model. The monitoring can be enriched to yield a nuanced understanding of drift in the machine-learned model which can allow for more targeted updates to the machine-learned model. The multiple observable drift parameters can provide enhanced flexibility and real-time visibility on model health and can assist a user in determining whether to retrain the machine-learned model or continue with a current deployed model in production based in part on a type(s) and/or severity of the observable drift. The processes described with reference to the industrial machine-learning operations model monitoring system can be hardware agnostic and can be applied to various industrial systems utilizing machine-learning models. Additionally, the system can be implemented on one or more cloud-based servers, thereby reducing processing demands on local client devices. In addition, for remote locations where internet connectivity could be an issue, the models can be deployed onto edge devices and the logs from those remote sites/devices can be later uploaded to the cloud (e.g., once connectivity is established) for tracking drift parameters in the MLOPs model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example operating environment for an industrial machine-learning operations model monitoring system.

FIGS. 2A and 2B depict examples of drift plots for an industrial machine-learning operations model.

FIGS. 3A and 3B depict examples of drift plots for an industrial machine-learning operations model.

FIG. 4 shows an example pipeline for an industrial machine-learning operations model monitoring system.

FIG. 5 is a flow diagram of an example process of an industrial machine-learning operations model monitoring system.

FIG. 6 is a block diagram of an example computer system.

Like reference numbers and designations in the various drawings indicate like elements.

### DETAILED DESCRIPTION

In the following description, for the purposes of explanation, numerous specific details are set forth to provide a thorough understanding of the present invention. It will be apparent, however, that the present invention can be practiced without these specific details. In other instances, well-known structures and devices are shown in block diagram form to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent one or more connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In this specification the term “engine” refers broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The present techniques include one or more artificial intelligence (AI) models that are trained using training data. The trained model(s) can subsequently be executed on data captured during real-time operation of a system, e.g., including industrial equipment. In some embodiments, the trained model(s) output a prediction of one or more operating conditions currently affecting the system during operation.

### System Overview

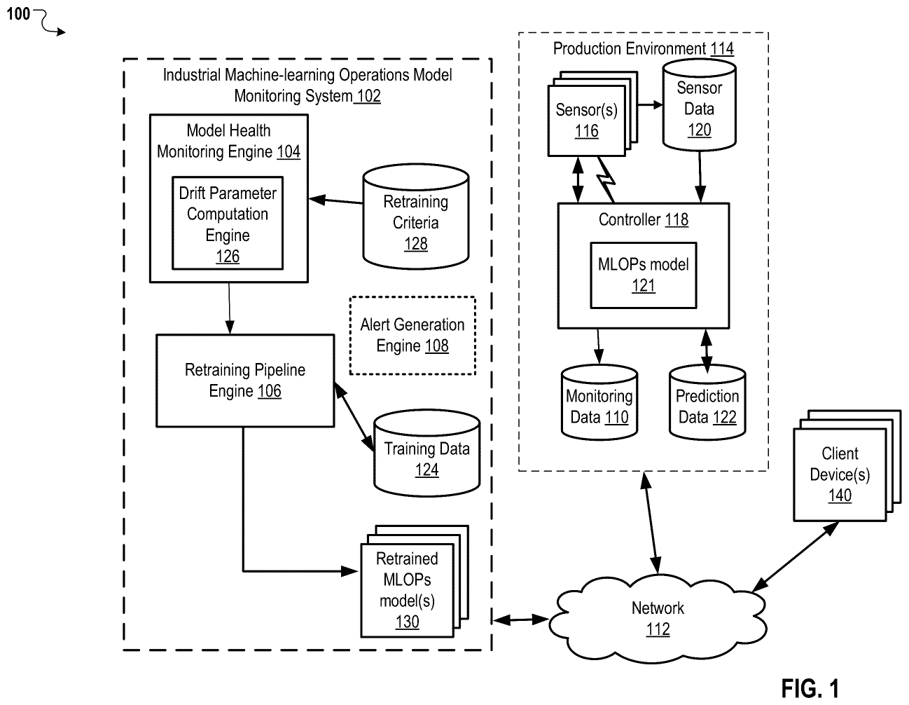

FIG. 1 depicts an example operating environment 100 for an industrial machine-learning operations model monitoring system. An industrial machine-learning operations (MLOPs) model monitoring system 102 includes a model heath monitoring engine 104, a retraining pipeline engine 106, and optionally an alert generation engine 108. Model health monitoring engine 104 is configured to receive monitoring data 110 over a network 112 from a production environment 114 and compute one or more drift parameters from the monitoring data 110. Industrial MLOPs model monitoring system 102 can be implemented on one or more servers, e.g., cloud-based server(s). The industrial MLOPs model monitoring system 102 can be configured to monitoring one or more production environments, e.g., two or more different production environments, each production environment including respective industrial equipment and deployed industrial MLOPs model(s).

A production environment can be, for example, a factory setting. In another example, a production environment can be a location in which a piece of industrial equipment is deployed. A production environment can include one or more pieces of industrial equipment performing one or more tasks in the production environment. Industrial equipment can include any number of components to achieve a predetermined objective, such as the manufacture or fabrication of goods. For example, industrial equipment includes, but is not limited to, heavy duty industrial tools, compressors, automated assembly equipment, and the like. Industrial equipment also includes machine parts and hardware, such as springs, nuts and bolts, screws, valves, pneumatic hoses, and the like. The industrial equipment can further include machines such as turning machines (e.g., lathes and boring mills), shapers and planers, drilling machines, milling machines, grinding machines, power saws, cutting machines, stamping machines, and presses.

Production environment 114 includes one or more sensors 116. The sensors can be used to capture data associated with the industrial equipment. The sensors 116 can be located throughout the production environment, for example, in proximity to or in contact with one or more pieces of industrial equipment. Sensors 116 can include one or more hardware components that detect information about the environment surrounding the sensor. Some of the hardware components can include sensing components (e.g., vibration sensors, accelerometers), transmitting and/or receiving components (e.g., laser or radio frequency wave transmitters and receivers, transceivers, and the like), electronic components such as analog-to-digital converters, a data storage device (such as a RAM and/or a nonvolatile storage), software or firmware components and data processing components such as an ASIC (application-specific integrated circuit), a microprocessor and/or a microcontroller. In examples, sensors 116 include hardware components that capture current, power, and ambient conditions. Sensors 116 can also include temperature sensors, inertial measurement units (IMUs) and the like. Sensors 116 can be configured to collect sensor data 120 including, for example, rotating component speeds, system electric current consumed by operating parts, machine vibration and orientation, operating temperature, and any other suitable characteristics that the industrial equipment can exhibit.

Sensors 116 can be in data communication with a central hub, e.g., a sensor hub, including a controller 118. Sensors 116 can be in data communication with controller 118 over a network 112 (or another network), e.g., a wireless or wired communication network. For example, sensors 116 can transfer captured raw sensor data using a low-power wireless personal area network with secure mesh-based communication technology. The network 112 can include one or more router nodes, terminating at an internet of things (IoT) edge device. In some embodiments, the network 112 enables communications according to an Internet Protocol version 6 (IPv6) communications protocol. In particular, the communications protocol used enables wireless connectivity at lower data rates. In some embodiments, the communications protocol used across the network is an IPv6 over Low-Power Wireless Personal Area Networks (6LoWPAN).

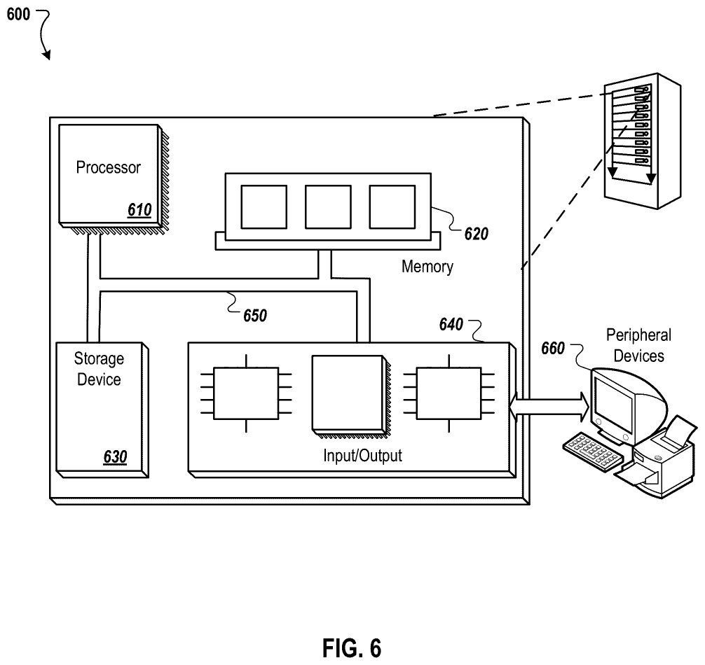

In some embodiments, the sensor data 120 is captured by one or more sensors and is collected by a controller 118. Controller 118 can be, for example, a computer system as described with reference to FIG. 6 below. Controller 118 can be an edge or cloud-based device. In some embodiments, the edge devices are deployed at an operational site, e.g., in a production environment 114. Controller 118 includes an industrial machine-learning operations (MLOPs) model 121, also referred to herein as a “MLOPs model.” MLOPs model 121 can receive the sensor data 120 and generate prediction data 122. Prediction data 122 can include predictions related to performing predictive maintenance of the industrial equipment, e.g., predictive maintenance of actuators used in the transportation sector, such as for fleet management for fuel tank systems, motion platforms, automation systems used in garbage trucks, etc.

MLOPs model 121 can be trained to predict an operating condition of the industrial equipment based in part on sensor data 120 captured of the industrial equipment before operation, during operation, after operation, or any combination thereof. The MLOPs model 121 can be an ensemble-based model created using the trained machine learning models, and the trained machine learning models generate prediction data including an operating condition of the industrial equipment. In some examples, an anomalous condition is a type of operating condition of the industrial equipment. In some embodiments, operating conditions include fretting, abrasive wear, and other conditions or any other anomalous conditions associated with typical industrial equipment like pumps, milling-drilling machines, compressors, etc. In examples, the MLOPs model 121 is trained using data generated while one or more predetermined operating conditions exist. Training dataset 124 can include labeled sensor data captured during multiple runs of experiments to isolate the effects of operating conditions of the industrial equipment.

Industrial MLOPs model monitoring system 102 includes training dataset 124. In some embodiments, a training dataset is generated from sensor data 120 captured by sensors 116 and used to train the MLOPs model 121. In some embodiments, a training dataset 124 can also include metadata. In examples, metadata includes a location of the industrial equipment, a number of active parameters associated with the industrial equipment, or any combinations thereof. The training dataset from the sensors 116 can be captured at two or more time intervals. In examples, the time intervals correspond to a number of days. By collecting data over a number of days, overfitting of the MLOPs model 121 is avoided. In examples, the two or more time intervals include at least a first time interval and a second time interval, the first time interval spanning a first amount of time during a given day, and the second time interval spanning a second amount of time during the given day, the second amount of time being shorter than the first amount of time and being separated from the first amount of time during the given day.

The training dataset 124 is labeled as corresponding to at least one operating condition, and a machine learning model is trained using a training dataset comprising the labeled additional sensor data. In some embodiments, the training dataset includes additional sensor data, additional temperature data, infrared heat maps of the product being produced, and images of an output material or finished product of the industrial machine. The machine learning model can be trained using any combination of the additional sensor data, additional temperature data, infrared heat maps of the product being produced by the industrial machine, and images of the product being produced by the industrial machine.

In some embodiments, MLOPs model 121 includes supervised and unsupervised machine learning. In some embodiments, a final prediction of an operating condition is derived using the ensemble of machine learning models, where predictions from multiple machine learning models contribute to the final prediction. A statistical mode (e.g., average) or voting scheme is applied to the multiple predictions from the ensemble of machine learning models to determine a final prediction of operating conditions associated with industrial equipment.

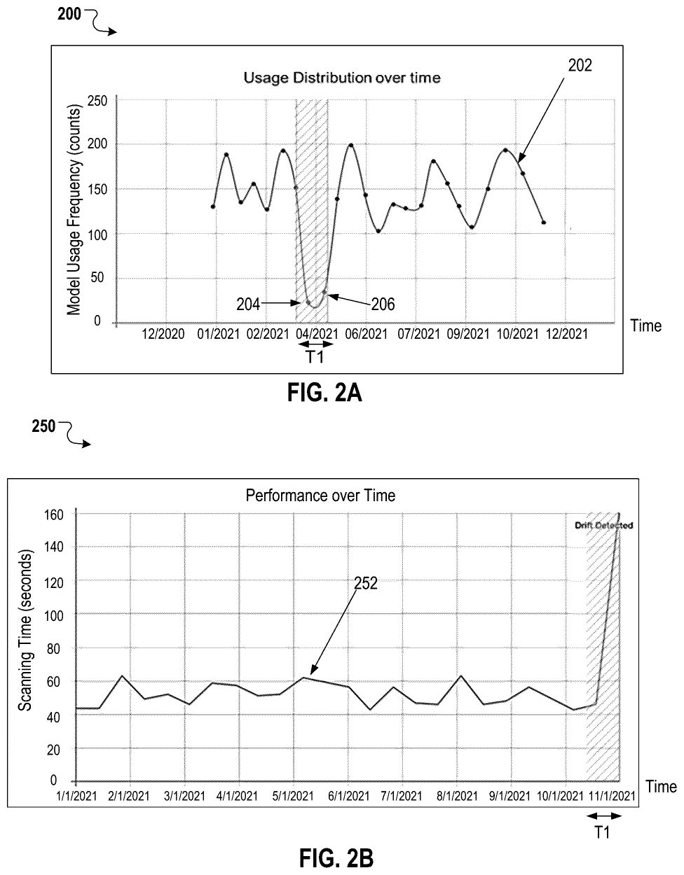

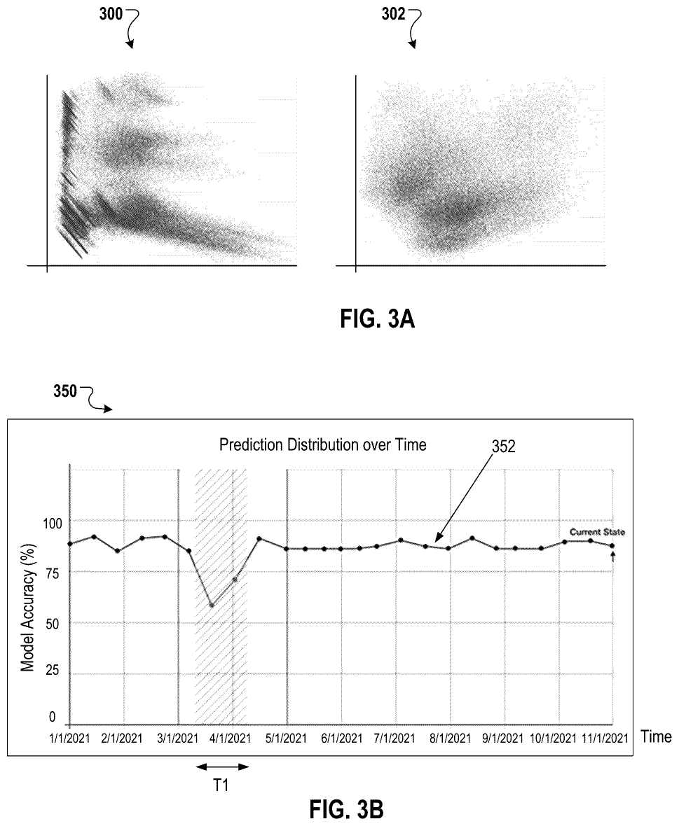

Model health monitoring engine 104 is configured to monitor, in an automated or semi-automated manner, health of the MLOPs model 121 in the production environment 114. Model health monitoring engine 104 receives monitoring data 110 from the production environment via network 112 and can compute, using a drift parameter computation engine 126, drift parameters for the MLOPs model, e.g., as described in further detail with reference to FIGS. 2A, 2B, 3A, and 3B below. Monitoring data 110 can include (A) model usage data, (B) model performance data, (C) sensor data, and (D) prediction data, each descriptive of a behavior of the MLOPs model 121 and/or the production environment in which the MLOPs model 121 is deployed. For example, model usage data can include a frequency with which the MLOPs model 121 is called by an end-user to perform an inference related to the production environment 114. In another example, model performance data can include compute times and resource usage by the MLOPs model 121 to perform inference tasks on received input data (e.g., sensor data 120). In another example, sensor data 120 is “in the wild” data collected by sensors 116 deployed in the production environment 114. In another example, prediction data includes predictions generated as output by the MLOPs model 121. Each of the aforementioned types of data can be used to determine a type of observable drift and compute a drift parameter, as described in further detail below. Monitoring data 110 can be generated by controller 118. For example, model usage data can be logged by controller 118 in response to each time the MLOPs model 121 is called by an end-user. In another example, performance data can be logged by controller 118 when the MLOPs model 121 is operating on the controller 118. In another example, model usage data can be generated by controller 118 in response to each time the MLOPs model 121 is called by an end-user and/or when the MLOPs model 121 is operating on the controller 118.

In some embodiments, calculation of drift parameters can be performed by the drift parameter computation engine periodically, e.g., biweekly, daily, hourly, monthly, or the like. A period of computation can be variable, for example, in response to a prior computation of a drift parameter being outside a threshold range. For example, system 102 can increase drift parameter computations in response to determining that a previous computation value is outside a threshold range of expected values. Calculation of drift parameters can be performed in response to a request by a user, for example, a technician performing maintenance.

In some embodiments, determining, by the model health monitoring engine 104, to retrain the industrial MLOPs model based on the monitoring data collected by controller 118 for the industrial MLOPs model includes computing drift parameters for the monitoring data and comparing the computed drift parameters to retraining criteria 128 for the drift parameters. Drift parameters can each be indicative of a type of observable drift of the industrial MLOPs model, e.g., observable drift in the prediction data generated by the model. Drift parameters can include, but are not limited to, (i) usage drift, (ii) performance drift, (iii) data drift, and (iv) prediction drift. Each drift parameter can have respective retraining criteria 128, where each retraining criterion for a drift parameter can include a trigger to initiate a retraining of the industrial MLOPs model. Retraining criteria 128 can be, for example, threshold values for each type of observable drift corresponding to the computed drift parameters. Retraining criteria 128 can be provided by a user, e.g., an owner of the industrial equipment, a equipment manufacturer, or an end-user of the industrial equipment.

In some embodiments, determining, by the model health monitoring engine 104, to retrain the industrial MLOPs model can depend on one or more drift parameters meeting (e.g., exceeding) respective retraining criteria 128. Determining to retrain the industrial MLOPs model can depend on meeting a respective retraining criterion of multiple (e.g., two, three, four, or more) drift parameters. In some embodiments, meeting a respective retraining criterion of a drift parameter includes determining a drift parameter value that is equal to or less than a threshold value. In some embodiments, meeting a respective retraining criterion of a drift parameter includes determining a drift parameter value that is equal to or greater than a threshold value. Further details related to drift parameters is described below with reference to FIGS. 2A, 2B, 3A, and 3B.

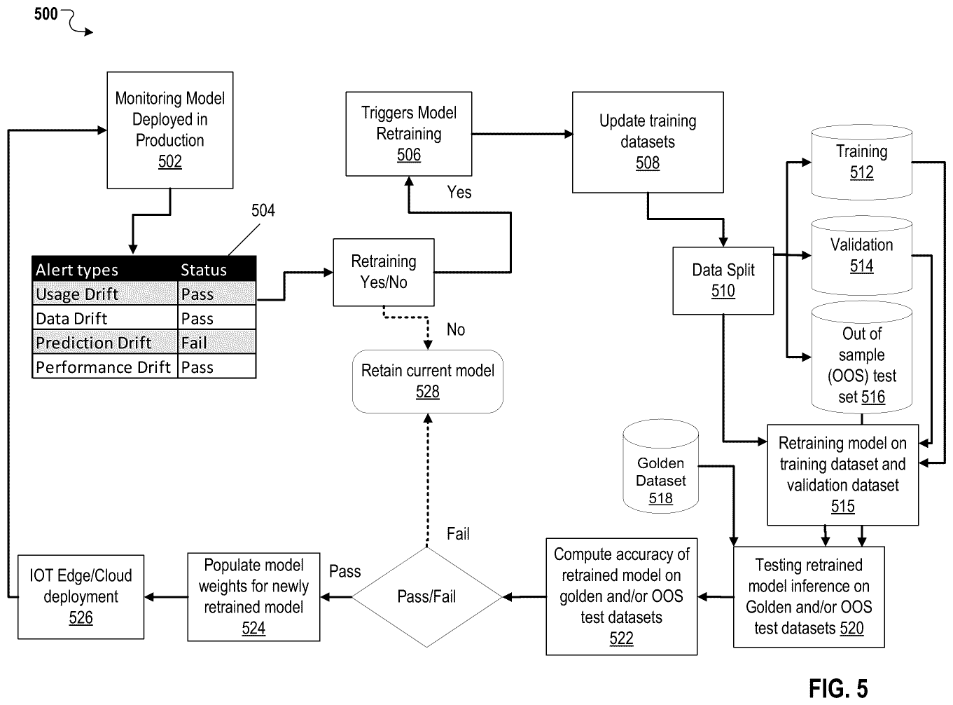

Retraining pipeline engine 106 can receive from the model health monitoring engine 104 a trigger to retrain the MLOPs model 121 as input. Retraining pipeline engine 106 can initiate a retraining pipeline for a deployed MLOPs model 121 and provide a retrained MLOPs model 130 as output. The system 102 can provide the retrained MLOPs model 130 to the production environment 114 to be used by controller 118 (e.g., the model 130 replacing the model 121) to generate predictions related to the industrial equipment. Further details related to the retraining pipeline are discussed with reference to FIG. 5.

In some embodiments, system 102 includes an alert generation engine 108. Alert generation engine 108 can generate one or more alerts to provide to one or more users. Alert generation engine 108 can generate the one or more alerts automatically in response to a trigger from the model health monitoring engine 104. The alert can be provided to the one or more users on client device(s) 140, for example, a tablet, computer, mobile phone, a display of a piece of industrial equipment, or the like. Alerts can be, for example, visual and/or audio-based notification. The alert can be provided in an application environment, e.g., graphical user interface, on the client device 140. The alert can include information related to the trigger, e.g., related to the drift parameters and retraining criteria. For example, the alert can include information related to a type of observable drift and/or a severity (e.g., rating) of the type of observable drift. The alert can include an interactive component for a user to provide feedback to the alert, e.g., to confirm initiation of a retraining pipeline. In some embodiments, retraining pipeline engine 106 is configured to wait for a confirmation from the user in response to an alert generated by the alert generation engine 108 before proceeding with updating the MLOPs model.

### Computation of Drift Parameters

Drift parameters can be representative of different types of observable drift, where each type of observable drift can be used to infer an operational/behavioral aspect of the MLOPs model behavior in the production environment and/or of the production environment in which the MLOPs model is deployed. Each type of observable drift can reveal a different characteristic of model behavior, such that assessing the model in view of multiple, (e.g., two or more), types of observable drift can offer nuanced understanding of the model behavior. FIGS. 2A, 2B, 3A, and 3B depicts example plots of different drift parameters, each calculated based on (i) usage drift, (ii) performance drift, (iii) data drift, and (iv) prediction drift of an MLOPs model. Monitoring multiple different types of observable drift can provide insight as to where in a prediction pipeline erroneous behavior is occurring. For example, data drift can indicate that a training dataset use to train the model is (e.g., substantially) not reflective of actual sensor data collected by sensors in the production environment. In another example, usage data can indicate that a model usage by an end-user is declining and can be reflective of a decline in model usefulness and/or accuracy as experienced by the end-user.

In some embodiments, a drift parameter indicative of an observable drift of the industrial MLOPs model is a usage drift. Usage of an MLOPs model can be characterized as a frequency of use of the MLOPs model deployed in a production environment. Usage drift can be utilized to describe patterns of usage of an industrial MLOPs model that is deployed in a production environment. Usage drift can indicate changes in frequency of use by an end user of an industrial MLOPs model that is deployed in a production environment. In some embodiments, an end user can be a user of an industrial system that utilizes the model to infer one or more aspects of system behavior. In some embodiments, an end user can employ an automated (or semi-automated) control system, where the control system can call the model to infer one or more aspects of system behavior. Usage of the MLOPs model can be measured periodically, for example, hourly, daily, weekly, bi-weekly, monthly, or the like. Usage data of the MLOPs model can be collected during the deployment of the model in the production environment. For example, from a most recent update to the MLOPs model (e.g., retraining of the MLOPs model) to a present time. Usage of the MLOPs model can be logged as a frequency or number of times that the MLOPs model is used for a period of time. For example, usage can be logged as a usage/day, usage/week, usage/month, or the like. Usage drift can be determined based on a measured usage being below a threshold usage over one or more measurements of usage. For example, usage drift can be determined based on a usage below a threshold usage for one or more sequential measurements of model usage. Usage drift can be determined by a threshold change in usage data, e.g., where the usage has decreased by an absolute or a fractional value of the nominal usage. For example, where the usage has decreased by a threshold value from an average usage, a target usage, or a previously measured usage value. The threshold value can be, for example, a minimum model usage threshold, where usage values below the minimum model usage threshold triggers a retraining criterion. Retraining criterion, e.g., a threshold value, can be defined by (i) an end user, (ii) a manufacturer of the industrial system, and/or (iii) a developer of the MLOPs model, to trigger a retraining of the industrial MLOPs. FIG. 2A depicts an example plot 200 of model usage frequency 202 over time of an industrial MLOPs model deployed in a production environment. As depicted, model usage frequency 202 includes a time period T1 where a model usage frequency includes collected usage counts that are below a threshold usage for two collected time periods 204, 206.

In some embodiments, a drift parameter indicative of an observable drift of the industrial MLOPs model is a performance drift. In a production environment, hardware resources available to the MLOPs model for performing computational tasks can be limited based on other parallel processes sharing the hardware resources. Performance of an MLOPs model can be characterized, for example, by a model compute time on available hardware resources. In another example, performance of an MLOPs model can be characterized as resource usage (e.g., of available hardware) for performing particular or known tasks. Model performance can be monitored for performing particular or known tasks. Performance drift can include a change (e.g., lengthening) in performance data, e.g., of an amount of compute time and/or a change (e.g., increase) in usage of available compute resources for performing particular and/or known tasks. Monitoring performance drift can ensure than the MLOPs model has sufficient compute resources to perform tasks. A retraining criterion based on performance drift can be a threshold change (e.g., increase) in model compute time or usage of available compute resources over a period of time. A threshold change can be an absolute or fractional increase in compute time, for example, with respect to (i) a target compute time, (ii) an average compute time, or (iii) from a previous measurement of compute time. A threshold change can be a compute time exceeding a threshold value. FIG. 2B depicts an example plot 250 of model compute (e.g., scanning) time 252 over time of an industrial MLOPs model deployed in a production environment. As depicted, model compute time 252 includes a time period T1 where a model compute time includes collected performance data that is above a threshold performance for the time period T1.

In some embodiments, a drift parameter indicative of an observable drift of the industrial MLOPs model is a data drift. Data drift can be characterized as a degree of deviation of training features and/or characteristics of collected data provided to the MLOPs model deployed in a production environment, e.g., “wild datasets.” For example, collected data can include sensor data 120 as described herein. In instances where collected sensor data includes features and/or characteristics that are a threshold deviation from those of the training dataset, a retraining criterion for a data drift parameter is triggered.

Data drift detection in features and/or characteristics between training dataset and collected sensor data can be performed utilizing one or more statistical methods. For example, statistical methods can include Kullback-Leibler, Jensen-Shannon Divergence, Kolmogorov-Smirnov Tests, or other appropriate statistical methods. A retraining criterion can include a distance metric and a corresponding threshold value for a clustering of features of the training data as compared to a clustering of features for collected data, where a user can define the threshold value to trigger a retraining pipeline.

In some embodiments, data drift includes monitoring collected sensor data provided to the deployed MLOPs model for expected data formats and/or data types. In other words, that input data to the MLOPs model matches data formats and/or data types that are compatible with the operations of the MLOPs model. Tracking data formats and/or data types can be performed utilizing metadata information. Metadata information can include, for example, data type, data format, data size, or the like. For example, monitoring data drift includes monitoring collected sensor data for matching data formats and/or data types with data formats and/or data types of the training datasets. For example, in a scenario where an MLOPs model can require input image data in 8-bit format and instead receives 16-bit format, monitoring data drift will trigger a retraining criterion for the MLOPs model. FIG. 3A depicts an example plot 300 of feature clusters for a training dataset, e.g., training dataset 124, and an example plot 302 of feature clusters for collected data 306 from a production environment in which an MLOPs model is deployed, e.g., sensor data 120. As shown, the cluster depicted in plot 302 and the cluster depicted in plot 304 are visually (e.g., statistically) different, which can be indicative of a training dataset that has a poor match (e.g., is significantly different) with real-world sensor data collected by sensors in the production environment.

In some embodiments, a drift parameter indicative of an observable drift of the industrial MLOPs model is a prediction drift. Prediction drift can be characterized by a decrease in accuracy of prediction data generated by the MLOPs model that is significant. Significance can be defined, for example, by a user-defined threshold, such that prediction data generated by the MLOPs model meet a threshold accuracy. In some embodiments, significance can be defined as a range of accuracy, where prediction drift occurs when prediction data generated by the MLOPs model that falls outside the range of accuracy. A user, e.g., field technician or product manager, using the MLOPs model in a production environment can perform periodic validation of the model predictions using a test subset of input data (e.g., a golden dataset) to measure an accuracy of the generated prediction data by the MLOPs model. Prediction drift can be determined based on a measured accuracy of the prediction data outside (e.g., or below) a threshold accuracy. A retraining criterion based on prediction drift can be a threshold change (e.g., increase) in prediction over a period of time. A threshold change can be an absolute or fractional decrease in accuracy, for example, with respect to (i) a target prediction accuracy, (ii) an average prediction accuracy, or (iii) from a previous measurement(s) of prediction accuracy. A threshold change can be a prediction accuracy below a threshold value. FIG. 3B depicts an example plot 350 of model accuracy 352 over time of an industrial MLOPs model deployed in a production environment. Prediction accuracy can be measured periodically and/or in response to observed changes in prediction accuracy (e.g., trending changes) in previous measurements. As depicted, prediction accuracy 352 includes a time period T1 where measured prediction accuracy includes data points that deviate from an average prediction accuracy for the time period T1.

### Example Processes of an Industrial Machine-Learning Operations Model Monitoring System

In some embodiments, monitoring an industrial MLOPs model includes determining to retrain the industrial MLOPs model, e.g., by the model health monitoring engine 104. Determining to retrain the MLOPs model depends on meeting a respective retraining criterion of one or more (e.g., two, three, four, or more) drift parameters. For example, determining to retrain the industrial MLOPs model can depend on meeting respective retraining criterion of drift parameters corresponding to observed (i) usage drift, (ii) performance drift, (iii) data drift, and (iv) prediction drift. In some embodiments, each type of drift parameter can be assigned a respective priority (e.g., weight), such that a drift parameter of a first type of observable drift can be more heavily weighted for triggering a retraining pipeline than a drift parameter of a second type of observable drift. Priority (e.g., weight) for each type of observable drift can be assigned by a user, e.g., a monitoring technician, manufacturer, or end user. The user can select a subset of drift parameters that can trigger retraining of the MLOPs model. Priority (e.g., weight) for each drift parameter can be dynamic. For example, the weights of each drift parameter to trigger retraining of the model can be variable based on goals/objective for the production environment, e.g., optimization of model performance, cost-benefit analysis, or a combination thereof. In some embodiments, a weight of each drift parameter to trigger retraining of the model can depend in part on a severity of observable drift of one or more drift parameters. For example, a deviation in model prediction accuracy (e.g., prediction drift) that severely exceeds a threshold deviation, e.g., greater than one standard deviation, a weight for the drift parameter corresponding to prediction drift can be adjusted to reflect the severity of the deviation (e.g., can be weighted heavily with respect to each other drift parameter). Thus, a severe deviation of a drift parameter can trigger a retraining pipeline regardless of whether another drift parameter has also triggered its respective retraining criterion. At times, determining to retrain the industrial MLOPs model can depend on at least two, at least three, or at least four drift parameters meeting respective retraining criteria.

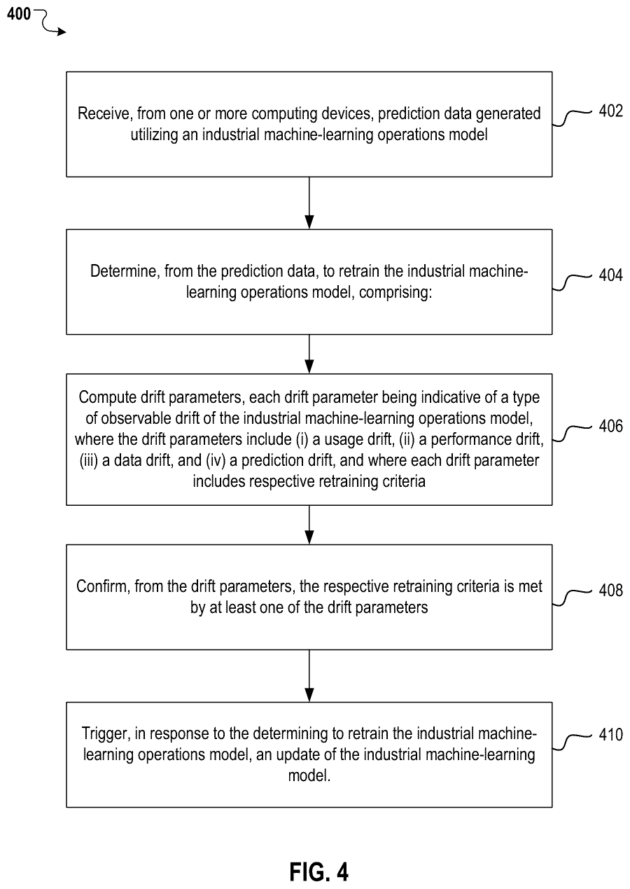

FIG. 4 is a flow diagram of an example process 400 of an industrial machine-learning operations model monitoring system. At 402, the industrial MLOPs model monitoring system 102 receives, from one or more computing devices, monitoring data for an industrial machine-learning operations model. The one or more computing devices, e.g., controller 118, can collect and/or generate monitoring data 110 including (A) model usage data, (B) model performance data, (C) sensor data, and (D) prediction data related to the behavior of the MLOPs model 121 and/or the production environment in which the MLOPs model 121 operates, and provide the monitoring data 110 to the system 102.

At 404, the system 102 determines, from the monitoring data, to retrain the industrial MLOPs model. Model health monitoring engine 104 can receive the monitoring data 110, e.g., over the network 112, and determine to retrain the MLOPs model 121. The determination that retraining is needed includes operation 406, in which the system 102 computes drift parameters, where each drift parameter is indicative of a type of observable drift of the MLOPs model. The drift parameters include (i) usage drift, (ii) performance drift, (iii) data drift, (iv) prediction drift, where each of the drift parameters includes respective retraining criteria. Drift parameter computation engine 126 computes drift parameters from the monitoring data 110. The determination that retraining is needed includes operation 408, in which the system 102 confirms, from the drift parameters, that the respective retraining criteria is met by at least one of the drift parameters. Model health monitoring engine 104 can determine, based on the computed drift parameters meeting one or more retraining criteria 128, to trigger a retraining pipeline for the MLOPs model.

At 410, the system 102 triggers, in response the determining to retrain the MLOPs model, an update of the MLOPs model. Retraining pipeline engine 106 receives from the model health monitoring engine 104, a trigger to initiate an update to the MLOPs model. An update of the MLOPs model can include generating, by alert generation engine 106, an alert provided to user(s) on client device(s) 140. Updating the MLOPs model can include an update of the training datasets, e.g., as described in step 508 of FIG. 5, and/or a retraining of the model, e.g., as described in operation 515 in FIG. 5.

In some embodiments, triggering an update of the industrial MLOPs model includes generating an updated industrial MLOPs model. Generating an updated MLOPs model can be performed by the industrial machine-learning operations model monitoring system 102, e.g., by retraining pipeline engine 106 depicted in FIG. 1. FIG. 5 shows an example pipeline 500 for an industrial machine-learning operations model monitoring system. At 502, A MLOPs model deployed in a production environment, e.g., production environment 114, is monitored utilizing one or more drift parameters 504 to determine if retraining criteria is met by one or more of the drift parameters 504. At 506, a retraining of the MLOPs model is triggered, e.g., by model health monitoring engine 104, in response to retraining criteria 128 being met by one or more computed drift parameters. Retraining the MLOPs model can include updating training datasets, e.g., training dataset 124. At 508, updating the training datasets can include reannotating/relabeling existing or new training datasets to consolidate with an existing training dataset. At 510, reannotated/relabeled training datasets are split (e.g., divided) into three categories: training dataset 512, validation dataset 514, and out of sample (OOS) test dataset 516. OOS test dataset 516 includes a set of selected datapoints that are separate from the training dataset 512. In addition, a golden dataset 518 includes a selected dataset during MLOPs model development and can be maintained constant (e.g., fixed) across each retraining of the MLOPs model. The golden dataset 518 includes a set of selected datapoints that are separate from the training dataset 512. The golden dataset 518 includes sufficient variability to represent collected (e.g., sensor) data from a production environment. At 515, the MLOPs model retraining is performed by training the model on the training dataset 512 and the validation dataset 514. At 520, model inference of the retrained (e.g., updated) MLOPs model is tested on the golden dataset 518 and/or OOS test dataset 516. At 522, an accuracy of the retrained MLOPs model is calculated on the golden dataset 518 and/or the OOS test dataset 516. An accuracy of the retrained MLOPs model can be calculated as a number of correct predictions for a total number of predictions generated by the model. The accuracy values (e.g., absolute values) of the retrained MLOPs model computed using the golden dataset 518 and the OOS test dataset 516 is compared to computed accuracies of the previous MLOPs model on the same golden dataset 518 and OOS test dataset 516. In instances where the computed accuracy of the retrained MLOPs model meets or is greater than a computed accuracy of the previous MLOPs model, the inference pipeline is populated, at 524, with the retrained model weights of the retrained MLOPs model. At 526, the retrained MLOPs model is deployed for use in production environments, e.g., production environment 114. For example, the retrained MLOPs model can be implemented in IOT edge and/or cloud-based applications. In instances in which a prediction accuracy of the retrained MLOPs model is calculated to be less than a prediction accuracy of the current (e.g., previous) MLOPs model, the current MLOPs model is retained, at 528.

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630.

The memory 620 stores information within the system 600. In some implementations, the memory 620 is a computer-readable medium. In some implementations, the memory 620 is a volatile memory unit. In another implementation, the memory 620 is a non-volatile memory unit.

The storage device 630 is capable of providing mass storage for the system 600. In some implementations, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In some implementations, the input/output device 640 can include one or more of a network interface device, e.g., an Ethernet card, a serial communication device, e.g., and RS-232 port, and/or a wireless interface device, e.g., and 802.11 card. In some implementations, the input/output device can include driver devices configured to receive input data and send output data to other input/output devices, e.g., peripheral devices 660, such as keyboard, printer and display devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially be claimed as such, one or more features from a claimed combination can in some cases be excised from the combination, and the claim may be directed to a sub combination or variation of a sub combination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for an industrial machine-learning operations model monitoring system, the method comprising:
receiving, from the one or more computing devices, monitoring data for an industrial machine-learning operations model;
determining, from the monitoring data, to retrain the industrial machine-learning operations model, the determining comprising
computing drift parameters, each of the drift parameters being indicative of a type of observable drift of the industrial machine-learning operations model, wherein the drift parameters comprise (i) a usage drift, (ii) a performance drift, (iii) a data drift, and (iv) a prediction drift, and wherein each drift parameter includes a respective retraining criteria, and
confirming, from the drift parameters, the respective retraining criteria is met by at least one of the drift parameters; and
triggering, in response to the determining to retrain the industrial machine-learning operations model, an update of the industrial machine-learning operations model.

2. The method of claim 1, wherein monitoring data for the industrial machine-learning operations model comprises monitoring (A) model usage data, (B) model performance data, (C) sensor data, and (D) prediction data.

3. The method of claim 2, wherein triggering the updated of the industrial machine-learning operations model comprises:
generating an updated industrial machine-learning operations model; and
providing, to the one or more computing devices, the updated industrial machine-learning operations model.

4. The method of claim 3, wherein generating an updated industrial machine-learning operations model comprises:
generating a refined training data set; and
retraining the industrial machine-learning operations model to generate the updated industrial machine-learning operations model.

5. The method of claim 4, wherein generating the refined training data set comprises one or more of (i) relabeling and/or reannotating an original training set, and (ii) generating a new training set including new prediction data collected by the one or more computing devices.

6. The method of claim 4, further comprising:
determining a first performance parameter for the updated industrial machine-learning operations model exceeds a second performance parameter for the industrial machine-learning operations model; and
providing, to the one or more computing devices, the updated industrial machine-learning operations model.

7. The method of claim 6, wherein determining the first performance parameter for the updated industrial machine-learning operations model exceeds the second performance parameter for the industrial machine-learning operations model comprises comparing a first output of the updated industrial machine-learning operations model utilizing an exemplary data set and a second output of the industrial machine-learning operations model utilizing the exemplary data set.

8. The method of claim 1, wherein drift parameters comprise weighted drift parameters, and wherein determining the respective retraining criteria is met by at least one of the drift parameters comprises
determining that a weighted retraining criteria is met by the weighted drift parameters.

9. The method of claim 1, wherein the data drift includes metadata drift.

10. The method of claim 1, wherein meeting the respective retraining criteria for each drift parameter of the drift parameters depends in part on the type of observable drift of the drift parameter.

11. The method of claim 10, wherein the respective retraining criteria is met by at least two of the drift parameters.

12. The method of claim 1, wherein triggering the update comprises providing an alert to initiate a retraining pipeline.

13. The method of claim 1, wherein triggering the update comprises triggering an automatic retraining of the industrial machine-learning operations model.

14. The method of claim 1, wherein determining the drift parameters based on usage drift comprises determining a frequency of utilization of the industrial machine-learning operations model by the one or more computing devices over a first period of time, and
wherein the respective retraining criteria for the drift parameter based on the usage drift comprises a minimum threshold usage of the industrial machine-learning operations model for a second period of time.

15. The method of claim 1, wherein determining the drift parameters based on performance drift comprises determining a compute time for the industrial machine-learning operations model on available hardware of the one or more computing devices, and
wherein the respective retraining criteria for the drift parameters based on the performance drift comprises a deviation of the compute time from an average compute time for the industrial machine-learning operations model on the available hardware of the one or more computing devices.

16. The method of claim 1, wherein monitoring data comprises prediction data, and
wherein determining the drift parameters based on data drift comprises determining a deviation of the prediction data generated utilizing the industrial machine-learning operations model from training data utilized to train the industrial machine-learning operations model.

17. The method of claim 16, wherein determining the drift parameters based on prediction drift comprises determining an accuracy in the prediction data is below a threshold prediction accuracy.

18. The method of claim 1, wherein triggering the update comprises providing an alert to a user; and
in response to receiving a confirmation from the user to initiate a retraining pipeline, initiating the retraining pipeline.

19. A system for updating an industrial machine-learning operations model, the system comprising:
one or more computers and one or more storage devices on which are stored instructions that are operable, when executed by the one or more computers, to cause the one or more computers to perform operations comprising:
receiving, from one or more computing devices, monitoring data for an industrial machine-learning operations model;
determining, from the monitoring data, to retrain the industrial machine-learning operations model, the determining comprising
computing drift parameters, each of the drift parameters being indicative of a type of observable drift of the industrial machine-learning operations model,
wherein the drift parameters comprise (i) a usage drift, (ii) a performance drift, (iii) a data drift, and (iv) a prediction drift, and
wherein each drift parameter includes respective retraining criteria; and
confirming, from the drift parameters, the respective retraining criteria is met by at least one of the drift parameters; and
triggering, in response to the determining to retrain the industrial machine-learning operations model, an update of the industrial machine-learning operations model.

20. One or more non-transitory computer storage media encoded with computer program instructions that, when executed by one or more computers, cause the one or more computers to perform operations comprising:
receiving, from one or more computing devices, monitoring data for industrial machine-learning operations model;
determining, from the monitoring data, to retrain the industrial machine-learning operations model, the determining comprising
computing drift parameters, each of the drift parameters being indicative of a type of observable drift of the industrial machine-learning operations model,
wherein the drift parameters comprise (i) a usage drift, (ii) a performance drift, (iii) a data drift, and (iv) a prediction drift, and
wherein each drift parameter includes respective retraining criteria; and
confirming, from the drift parameters, the respective retraining criteria is met by at least one of the drift parameters; and
triggering, in response to the determining to retrain the industrial machine-learning operations model, an update of the industrial machine-learning operations model.
